(19) United States
(12) Patent Application Publication
(10) Pub. No.: US 2009/0282023 A1
(43) Pub. Date: Nov. 12, 2009

(54) SEARCH ENGINE USING PRIOR SEARCH TERMS, RESULTS AND PRIOR INTERACTION TO CONSTRUCT CURRENT SEARCH TERM RESULTS

(76) Inventor: James D. Bennett, Hroznetin (CZ)

Correspondence Address: GARLICK HARRISON & MARKISON, P.O. BOX 160727, AUSTIN, TX, 78716-0727, US

(21) Appl. No.: 12/368,982

(22) Filed: Feb. 10, 2009

Related U.S. Application Data
(60) Provisional application No. 61/052,461, filed on May 12, 2008.

(51) Int. Cl. G06F 17/30

(52) U.S. Cl. 707/5; 707/3; 707/10; 707/E17.014; 707/E17.017; 707/E17.109; 707/E17.108; 707/E17.111; 707/E17.119

(57) ABSTRACT

An Internet infrastructure contains a search server that delivers search result pages of search results or web sites to client devices based upon a search string. The search results provided to the user take into account prior search terms entered by the user, and may take into account user interaction (or lack thereof) with prior search results as well as additional information other than just the search string and popularity ranking of web pages on the Internet. Specifically, a web browser contained in the client devices displays a first set of search result pages of web sites delivered by the search server in response to a search string. Then, in response to a modified search string and/or monitored and processed user interaction with prior search results, the search server delivers a second set of search result pages, comprising more relevant search information.

### CROSS REFERENCES TO PRIORITY APPLICATIONS

This application claims priority under 35 U.S.C. 119(e) to U.S. Provisional Application Ser. No. 61/052,461, filed May 12, 2008, co pending, which is incorporated herein by reference in its entirety for all purposes.

### BACKGROUND

1. Technical Field

The present invention relates generally to Internet servers, computers, and infrastructures; and, more particularly, to search engines running thereon.

2. Related Art

Search engines provide a way to explore the World Wide Web in ways that are not possible in any other manner. In other words, search engines act as a gateway to the Internet. Users access search engines for a wide variety of purposes, such as to search for data, results, or organizations whose details are imprecisely known, to search for information that is available in the Internet, to search for specific content and downloads (movies, music, games, and other entertainment and information files), to search for news and news related audio/video downloads, to search for medical help, to search for machine-executable software downloads, etc.

Search engines typically receive user input or search terms intended to frame the search process and then identify a search result list containing search results and sort the search result list based upon hit accuracy and prior user selection popularity. The results are typically displayed in groups of 10 or so to a user and a ‘next’ button may be used to allow the user to progress the next search result page. If a user does not find what they were looking for in the first few pages of search results presented to the user, subsequent pages are unlikely to yield useful results. Search engines can fail to find relevant content in a search because search engines are used for a wide variety of purposes as mentioned above and search engines often fail to immediately recognize the specific purpose of a user or a specific search operation. Therefore, results become vague and unfocused to the user's purposes, many pages of results, even tens or thousands of pages of results, can yield very little user desired web links or data.

Modifying the search string through user interaction often yield the same web links, page after page, making user abandon the search session or try another new search string over time. Users make up search strings on a conjecture basis, without knowing how search engines work, and in addition user's intentions of using search strings vary widely. Popularity based search results (search algorithms that return the most popular and commonly-sought after data and information on the Internet) often do not yield the user's desired results because of failure to take other data and processing into account.

If a user desires to find a list of top bicycle riders in the world, for example, the user may enter ‘top bicycle riders’ as the search sequence and may receive a long sequence of bicycle sales and renting sites, bicycle magazine sites, bicycle parts information, stray bicycle related sites, etc., page after page. The user, since they did not get their desired results in the initial page, may step through several screens via the ‘next’ button and search many pages of search results. After a while, the user may decide to modify the search strings by adding a term or two, and/or simply start over. For example, the user may add the term ‘ranking’ to the prior sequence, click on ‘next’ button and cross their fingers for better search results to be obtained. This sequence of steps by the user may again results in many of the same previously found that were unhelpful, or may provide new search results to the users that are equally as uninteresting as the previously-found results.

These and other limitations and deficiencies associated with the related art may be more fully appreciated by those skilled in the art after comparing such related art with various aspects of the present invention as set forth herein with reference to the figures.

### BRIEF SUMMARY OF THE INVENTION

This application is directed to apparatus and methods of operation that are further described in the following Brief Description of the Drawings, the Detailed Description of the Invention, and the claims. Other features and advantages of the various embodiments will become apparent from the following detailed description of the invention made with reference to the accompanying drawings.

### BRIEF DESCRIPTION OF THE DRAWINGS

FIG. 1 is a schematic block diagram illustrating an Internet infrastructure containing a client device and a web-browser-accessible search server, wherein the search server delivers web link lists for a current search based upon prior search terms, results, and user interactions;

FIG. 2 is a schematic block diagram illustrating components of the search server constructed in accordance with the embodiment of FIG. 1;

FIG. 3 is a flow diagram illustrating functionality of the search terms, results and interaction module illustrated a operating on the client device in FIG. 1, wherein the search terms, results and interaction module gathers prior user terms, results, and user interaction data and sends it to the search server for use in subsequent search processing;

FIG. 4 is a flow diagram illustrating the functionality of the search server of FIG. 1 upon receiving a search string from web browser of a client device in FIG. 1;

FIG. 5 is a flow diagram illustrating the functionality of the search server of FIG. 1;

FIG. 6 is a flow diagram illustrating functionality of the search server of FIG. 1, in more detail than previously illustrated in FIG. 5;

FIG. 7 is a block diagram illustrating a snap shot of a first set of search result pages based on a search string delivered by a web browser, wherein first set of search result pages contains lists of web links sorted on the basis of popularity ranks; and

FIG. 8 is a block diagram illustrating a snap shot of a second set of search result pages based on a search string delivered by a web browser, wherein the second set of search result pages contains refined list of web links sorted on the basis of prior terms, results and user interactions using the processing taught herein.

### DETAILED DESCRIPTION OF THE DRAWINGS

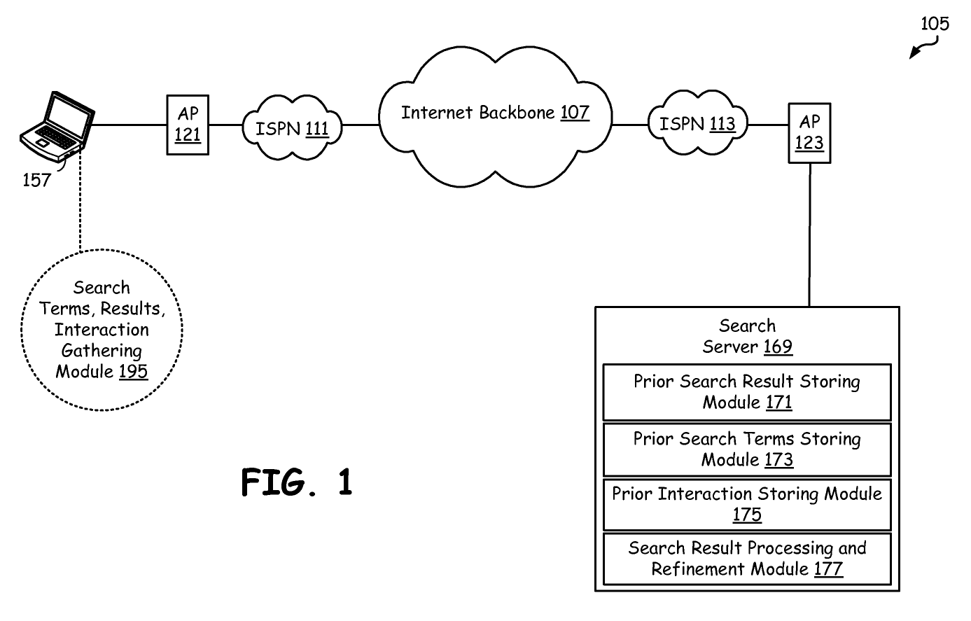

The general idea of enhancing Internet or other data searches by processing and considering prior interactions the user is having with search results, prior searches, user historical interests and profiles, and like historical data can be illustrated and discussed generally with respect to FIG. 1. FIG. 1 is a schematic block diagram illustrating an Internet infrastructure 105. Infrastructure 105 contains a client device 157 coupled to a web-browser-accessible search server 169. The search server 169 in FIG. 1 delivers web link lists (or other forms of search results) based upon prior search terms, prior search results, and user interactions with browser, data, or client device. Specifically, the search server 169 gathers and stores the prior search terms and results delivered to web browser of the client device 157 and utilize some or all of these prior search terms and results to exclude web links that a user of the client device 157 is likely not interested in. This process of pairing down provided search results by eliminating content that the user is not interested in seeing continues over an entire search session, and can progressively provide the user with more useful information as the server become more aware or “in tune” with what the user desired to see for search results. The search session constitutes a series of delivery of search result pages based on an original search string or any number of modifications of it. That is, even when the user adds terms to or deletes terms from the original search string, the search server 169 continues to take into account prior search results and user interactions (maybe even from prior searches) along with original or any number of modified search strings and deliver refined search result pages to the user. The refined search results will exclude web links that are similar to the ones that user historically or previously showed no interest in via previous search result pages or via previous search operations.

The search server 169 typically first identifies and sorts, without considering prior terms and results, search result web links based on popularity. In another embodiment, the first search could also be based on a prior user profile or search history for the user in the hope of refining the search on the first search attempt. In both cases and n response to a search string received from the client device's web browser, the server delivers a first search result page that is sorted on the basis of popularity. After delivery of this first search result page that is sorted on the basis of popularity, the search server 169 awaits for the clicking of one or more of a ‘prev’, ‘next’, or ‘refine search’ button or buttons. These buttons are rendered or displayed to the user along with the first search result page. A clicking of ‘refine search’ button results in the server gathering various user interactions that the user had with the browser, server, search results, or other data. These interactions and data include the duration that a search result or web page was opened. The amount of time a web page or search result is viewed or opened (or the fact that a search result or web page was not viewed or opened at all) can be used to determine user interests. This information, along with the search string information, and the generating and sorting subsequent web links and user interaction data, may be used to rapidly improve search result desirability to the user in shorter periods of time.

In addition, suppose the user modifies the original search string they entered by adding a term. In this case, the search server 169 attempts to determine user interests by using the newly modified search string, but also generates and sorts subsequent web links on the basis of not only the modified search string but also on the basis of prior search terms and results. For example, a first set of search result pages may be delivered on the basis of an original search string. The server or browser may or may not have tried to refine the search terms based on user interaction with search results or historical user profiles and results. After some clicking of the ‘next’ or ‘refine search’ buttons on each of these first set of search result pages (resulting is potentially more user interaction search optimization), the user may modify the search string by adding a term to it, deleting a term from it, or changing the logical search construct (i.e., change a “and” to an “or” in the search information, etc). This new input to the search string results in a second set of search result pages, and the process to find this second set of search result pages may attempt to exclude web links that are similar to the web links in the first set of search result pages, and generating new list of sorted web links. Often, this is due to the fact that an assumption is made that the user is still looking for the same information they started looking for, and what was valuable or less valuable to them user when processing the old search string, still applies to the new search string. The exclusion of web links and generation of second set of search result pages is determined by: (a) the user showing little interest in any of the web links in the first set of search result pages, which is indicated by not opening most of the web links in the first set of search result pages; (b) the user showing a lot of interest in a few web links or search results in the first set of search result pages, which is indicated by opening or spending a lot of time in a certain web page or search result, whereby it can be inferred that the other search results or web pages presented to the user alongside these accessed results were of less interest; (c) the user modifying the search string, which indicates that the user hasn't received what he/she wanted in the first set of search result pages; and/or (d) the user interactions with the first set of search result pages such as opening of web links for a short duration, which determines user's lack of interest in that kind of web links.

In FIG. 1, a search terms, results, interaction gathering module 195 is incorporated into the client device's 157 web browser either via software, hardware, or a combination of added software and hardware to the client device 157. This module 195 (also called a user interaction gathering module) gathers prior search terms, results and user interaction with the first and subsequent set of search result pages for a search operation, and may collect search results and tendencies across many different searches spanning long durations of time. In this case, a user profile of how, what, and why they search for data, and the revealing of trends in macro search patterns can be identified. The user may be in the medical profession, and often search for things related to the medical field of study. This can be used to refine all searches this user makes, for all time, and likely assist the user in finding more meaningful content. For a specific search or string of searches, the search terms, results, interaction gathering module 195 generates user interaction data and statistics such as the category in a displayed search result page(s) from which the user opens a web page, and how long the web page is opened etc., along with the prior search strings (terms) and search results. The search terms, results, interaction gathering module 195 monitors user interaction from the beginning of delivery of a search result page until a button is clicked. This user interaction data along with prior search terms and prior search results, within a session, are transferred to the search server 169 periodically or upon the pressing of the buttons provided with the search result pages.

To facilitate the search procedure for the user of the client device 157, the displayed search result page provides ‘prev’ (previous), ‘next’ and ‘refine search’ buttons on the screen for use by the user. The ‘prev’ button allows the user to view exact preceding page that was displayed before, without any modifications. This allows the user to go back to preceding search result page, as needed. In this case, the search terms, results, interaction-gathering module 195 includes the gathered user interaction data from the preceding page displayed. The ‘next’ button provides a next search result page to the user, that page contains the next few popularity ranks in a next search result page, all from within the first set of search results the server found from processing the last search operation. In one form of operation, the ‘next’ button will not provide the narrowed or refined search results to the user using user interaction data, and only facilitates the user to proceed to the next search result page containing next few of the popularity ranked web pages derived from the original search using standard search algorithms. In another embodiment, the ‘next’ button may be programmed or used to automatically take into account user interaction information and attempt to filter more useful information into one or more ‘next’ search pages presented to the user over time.

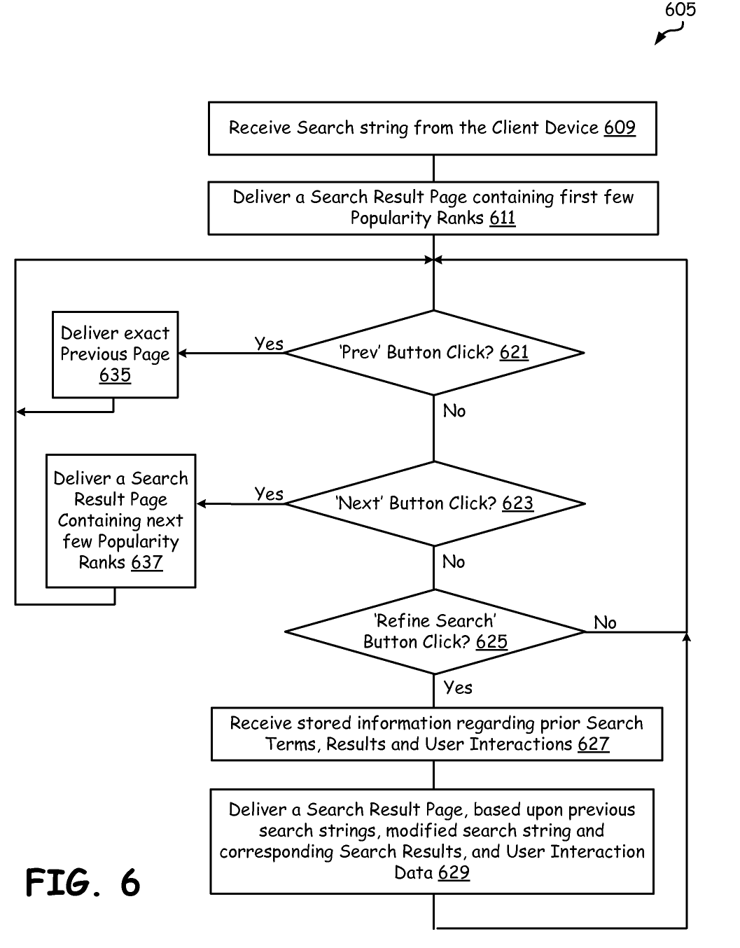

The ‘refine search’ button is specifically provided to allow search server 169 to refine a search result according to the user interaction and needs. That is, the ‘refine search’ button provides an option to the user of the client device 157 to allow the search server 169 to use user interaction data, prior search terms and search results, and refine the subsequent search results provided to the user on this basis. The refined search result page may contain web links or search data that are far different from initial sorting of web links on the basis of popularity ranks, thereby making these narrowed-down subsequent search result pages more relevant to the user. More detailed description of the ‘prev’, ‘next’ and refine buttons can be found with reference to the FIGS. 6, 7, and 8 herein.

The Internet infrastructure 105 of FIG. 1 includes an internet backbone 107 communicatively coupling client device 157 and to the search sever 169 via ISPNs (Internet Service Providers Networks) 111 and 113, and APs (Access Points) 121 and 123. Other hardware, networks, protocols, and/or software may be used to connect one or more client device to one or more servers, and such systems may be open, public, or proprietary. The search server 169 contains prior search result storing module 171 that stores the prior search results (web links displayed in the prior search result pages in a given session) gathered from search terms, results, interaction gathering module 195 that is stored within or operating in conjunction with in the client device 157. A prior search terms storing module 173 stores the prior search terms (search strings provided by a user in the prior search result pages in a given session) gathered from search terms, results, interaction gathering module 195 in the client device 157. In another embodiment, the search server 169 may retain the prior search terms and results in server memory, without needing the search terms, results, interaction gathering module 195 to send these results and terms back to the search server 169.

A prior interaction storing module 175 stores the user interactions (from the prior search result pages in a given session) gathered from search terms, results, and interaction gathering module 195 in the client device 157. A search result processing and refinement module 177 analyzes the gathered user interaction data, prior search terms and results and arrives at conclusions regarding how to generate, sort/prioritize the web links of the subsequent search result pages. In FIG. 1, the modules 171-177 may be software stored in memory and executed by a general purpose CPU or may be specific and dedicated hardware and/or software that may function solely to do the functions stated above in a secure and dedicated manner.

As an example of the operation of FIG. 1, a user of the client device 157 may enter an original search string ‘top bicycle riders’ in an opening search page of the search server 169 website, in an attempt to find a list of top bicycle riders in the world. These results are provided to the user in a first of a first set of search result pages with the first few popularity ranks. These web links may include some useful web links with most other web links being of no interest to the user.

After stepping through several subsequent search result pages of the first set of search result pages by clicking on ‘next’ or ‘refine search’ buttons and not getting many web links of interest, the user may attempt to start over. The user may modify the search string by adding a term ‘ranking’ to the original search string and click ‘refine search’ button.

The modifying of the original search string and clicking of ‘refine search’ button results in the first of second set of search result pages being refined on the basis of prior search terms (here it is ‘top bicycle riders’), prior search results (resulting in web links that are of no interest to the user), and prior user interactions as recorded by either the client device 157 (via module 159) or as stored and processed via the modules 171-177 of server 169. The prior user interactions may include opening of web links in the first set of search result pages for a short duration indicating lack of user interest in these web links, or for a long duration with many embedded sub-clicks on embedded content that indicate a lot of interest in that search result. The refined search results of the first of second set of search result pages may exclude web links that are similar to the web links the first set of search result pages, may exclude web links that are of little or no interest to the user based upon user interaction data and may include web links that user showed interest in or more web links similar to the ones in which the user showed the most interest. Thus, the second set of search result pages may be resorted on the basis of popularity ranks and user interaction data, excluding many of the web links that are similar to the first set of search result pages. Given this process, the user may be presented with more meaningful and relevant data, search results, and web pages/links, in a shorter period of time, with less user time spent engaged in manual searching for the desired content.

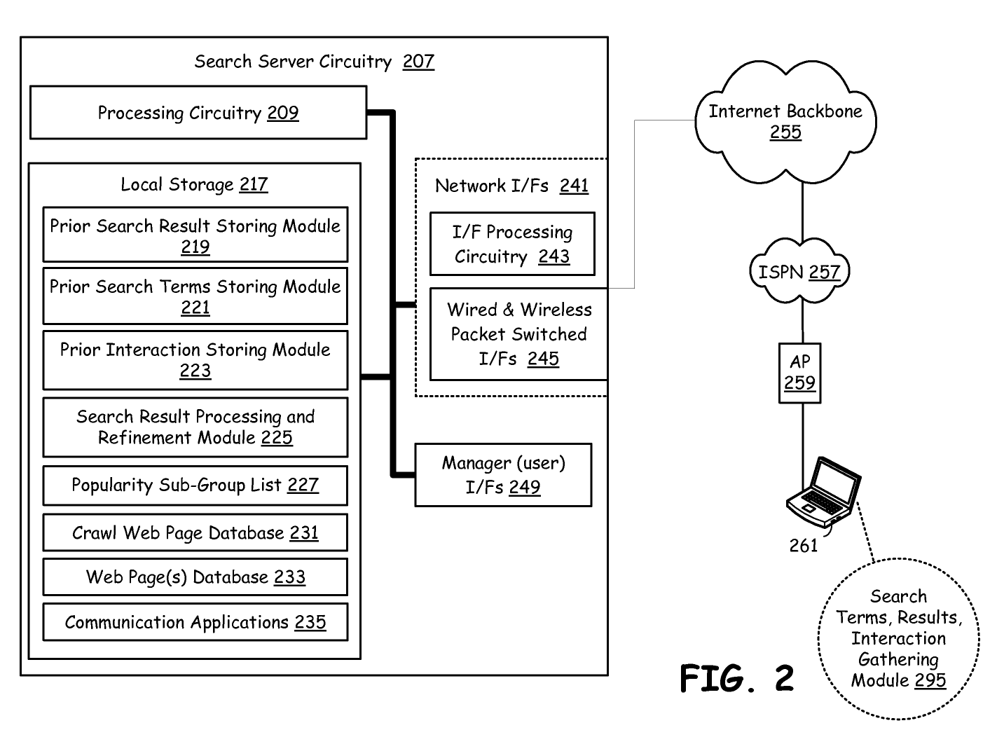

FIG. 2 is a schematic block diagram illustrating components of a search server constructed in accordance with the server 169 as illustrated in the embodiment of FIG. 1. The search server circuitry 207 may in part or full be incorporated into any computing device that is capable of serving as an Internet based server, such as the server 169 of FIG. 1. The search server circuitry 207 generally includes processing circuitry 209 (i.e., a central processing unit (CPU), digital signal processor, graphics processor, microcontroller, or some combination thereof), local storage 217 (i.e., dynamic or static random access memory, optical storage, hard drive storage, magnetic memory, nonvolatile memory, or other computer storage in any combination), manager interfaces 249, and network interfaces 241. These components are communicatively coupled to one another via one or more of a system bus, dedicated communication pathways, or other direct or indirect communication pathways that often contain control bits/lines, address lines, data lines, and/or other electrical signal paths operating using parallel or serial communication protocols. The processing circuitry 209 may be, in various embodiments, one or more of a microprocessor, a digital signal processor, a state machine, an application specific integrated circuit, a field programming gate array, or other processing circuitry and may contain software routines and firmware stored in conjunction with this hardware to assist the hardware's operation.

Local storage 217 may be random access memory, read-only memory, flash memory, a disk drive, an optical drive, another type of memory that is operable to store computer instructions and data, or any combination thereof in any size or quantity. The local storage 217 includes prior search result storing module 219, prior search terms storing module 221, prior interaction storing module 223, search result processing and refinement module 225, popularity sub-group list 227, crawl web page database 231, web page(s) database 233 and communication applications 235 to facilitate user searching in accordance with the embodiments taught herein.

The prior search result storing module 219 temporarily stores prior search results in a given session that is gathered from search terms, results, interaction gathering module 295 incorporated in a client device 261. These stored search results may be time sequentially identified or ordered so that the sequence of their generation is known to the system of FIG. 1 or FIG. 2. Alternatively, the prior search results may also be stored while delivering each search result page. The prior search terms storing module 221 stores the prior search terms and alterations, addition, and subtractions thereto in a given session gathered from search terms, results, interaction-gathering module 295 in the client device 261. Alternatively, the prior search terms may also be stored while delivering each search result page. The prior interaction storing module 223 stores the user interactions in a given session gathered from search terms, results, and interaction gathering module 295 in the client device 261. The prior interactions may include any of the user interactions with search results or searchable web pages/links, such as duration of a web page opening, content that was skipped by the user, number of clicks within a search result or web page, a recording of the type of content visited in the search results (video, PDF, text, pictures, ads, etc), the type of sub-links clicked on within search results, user input into the browser to assist in identification of valuable content, etc. The search result processing and refinement module 225 analyzes the gathered user interaction data, prior search terms, and/or prior search results and thus determines how to generate, sort/prioritize the web links of the subsequent search result pages. The search result processing and refinement module 225 also handles the functionalities of ‘refine search’ buttons which provides an option to the user of the client device 261 that allows the search server 207 to use user interaction data and produce refined search result pages.

The popularity sub group list 227 is a database that contains lists generated on the basis popularity, to be displayed in a subsequent search result page(s). It may also contain preceding search result pages to be displayed upon clicking ‘prev’ button. Crawl web page database 231 and web page(s) database 233 contain lists of web pages links that are obtained upon the search server crawling through the web sites during routine collection of web links and pages. There may be hundreds, thousands, or more of web links, pages, and search results that are identified for any given search via the module 233. Communication applications 235 allow the search server 207 to provide user with pop-up window questionnaires and choices as a part of gathering data that determines user interests among search results and searched web pages/links and allows the system to better zero in on the user's intentions for the search. These interactive questionnaires and choices, initiated by the user or by the server, browser, or client device itself, allow a user to refine searches according to their needs.

The network interfaces 241 contain wired and/or wireless packet switched interfaces 245 and may also contain built-in or an independent interface processing circuitry 243. The network interfaces 241 allow search server 207 to communicate with client devices, AP equipment, ISPN, or other communication infrastructure such as the client device 261, Internet backbone 255, ISPN 257, AP 259, and other possible hardware and/or software not specifically illustrated in FIG. 2. The circuitry 241 allows the server 207 to communicate with the client device and exchange search result pages/links and user interaction data as necessary to allow the search operation to be completed for the user. The manager interfaces 249 may include a display and keypad interfaces to allow the server 207 to be interfaced to a network manager interface to enable IT support and facilitate further processing, monitoring, and programming of the server 207. These manager interfaces 249 allow an IT professional or an on-site user at the search server to control aspects of the system. The client device 261 illustrated is communicatively coupled to the search server 207 via an Internet backbone 255, ISPN 257, and AP 259.

In other embodiments, the search server 207 of the present invention may include fewer or more components than are illustrated as well as lesser or further functionality. In other words, the illustrated search server is meant to merely offer one example of possible functionality and construction in accordance with the system of FIG. 1, but other communication protocols exist and will work in accordance with the search methodologies taught herein.

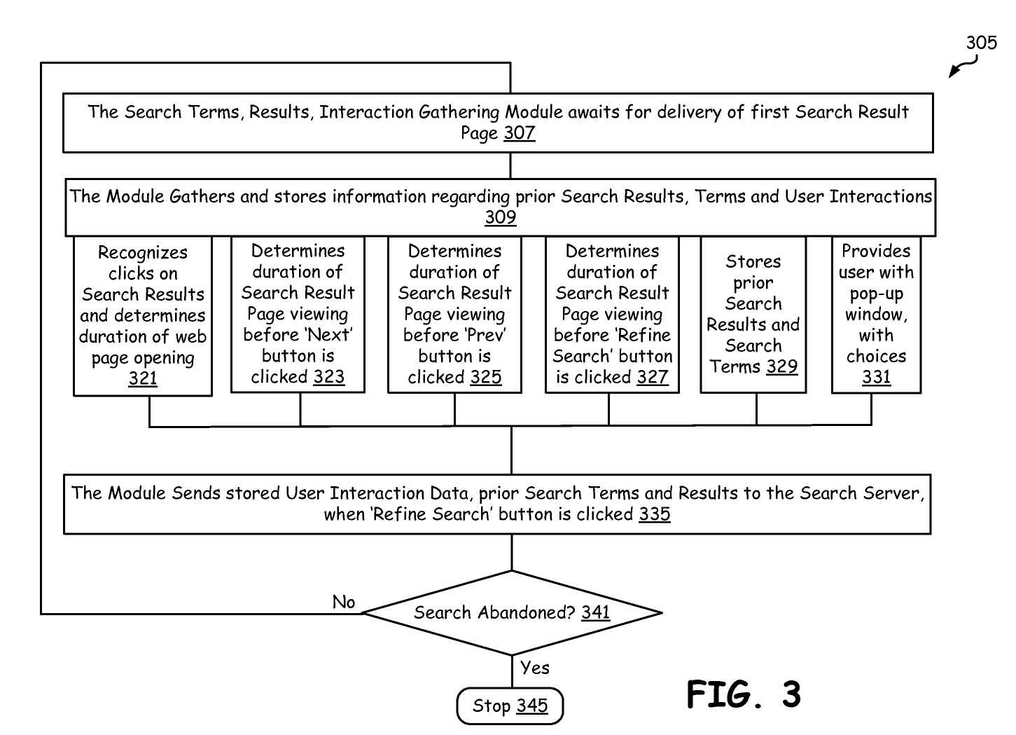

FIG. 3 is a flow diagram illustrating a series of steps or a process 305 that is performed by the search terms, results and interaction gathering module 195 of FIG. 1, wherein the search terms, results and interaction module gathers prior user terms, results and user interaction data and sends it to the search server as discussed previously with respect to FIGS. 1-2. The functionality shown within FIG. 3 begins with the search terms, results, interaction-gathering module (e.g., module 195 or 295 in FIGS. 1 or 2 respectively) in a client device (e.g., devices 157 and 261 in FIGS. 1 and 2 respectively) waiting for delivery of a search result page via a block or step 307. Once the search result page is delivered to the user, the step 309 is performed. At a next block or step 309, the user begins to interact with the delivered search result page, the search terms, search results, etc, and interaction gathering module begins to gather information about user's search needs, tendencies, interests, lack of interest, focus, etc. In addition, search terms, results, and interaction gathering module 195 gathers terms and results (web links) delivered in the current search result page. The gathering of information regarding user needs and interaction with searchable content occurs in one of the many possible ways, some of which are shown in blocks 321, 323, 325, 327, 329 and 331 of FIG. 3.

Via the block or step 321, the search terms, results and interaction gathering module 195 recognizes clicks on search results (web links displayed in the search result page) and determines the duration for which the web pages are opened. This data provides the search server information about user intentions such as what type of web links the user is looking for or not looking for and potentially what type of specific content or key phrases/material the user is focusing on via his search efforts. For example, a long duration of opening of web page may inform the search server that user is interested in that kind of web pages., or a lot of clicking and following of sub-links within one search result or searchable web page may indicate significant interest in that type of content. At the next block 323, the search terms, results and interaction gathering module 195 determines the duration of search result page viewing before a ‘next’ button is clicked. For example, a long stay on the current search result page may indicate the search server that the user is interested in the current search result page that is displayed. However, a quick move through a page without stopping to view the content much may indicate moderate to low interest. At the next block 325, the search terms, results and interaction gathering module 195 determines the search result page viewing before a ‘prev’ button is clicked. At the next block 327, the search terms, results and interaction gathering module 195 determines the duration of search result page viewing before a ‘refine search’ button is clicked. At the next block 329, the search terms, results and interaction gathering module 195 gathers information about prior search results and terms. If not informed by the search server to gather this information, the search terms, results and interaction gathering module may skip this part. However, it is often useful to gather search information not only in this current search session, but correlating user behavior to prior search sessions or the location/context of the search for that user. For example, a user that is searching from work can be assumed to be looking for work related information. If that user is an auto mechanic, the search algorithm can favor auto repair related information instead of just popularity information when presenting the user with search data. If the user is searching from France, he may want more references written in the French language. If the search is coming from the physics building of a local university, the server may assume a certain set of content is desired relating to physics and education. If the user is searching after 6 PM at night, and most of the time the user is searching for the location of good local restaurants at that time, then the server can serve up content more toward that search motive. If the user is often looking for music MP3 files, the server can adjust searches accordingly. At the next block 331, the search support module provides user with pop-up window, providing questionnaire and choices intended to gather user's intentions regarding the current search. At a next block 335, the search support module 195 sends the gathered user interaction data, prior search results and search terms to the search server, when ‘refine search’ button is clicked or another event happens within the system.

The search terms, results and interaction gathering module 195 then determines, via a next decision block or step 341, if the search is abandoned (that is, the search session is completed). If yes, the functionality of search terms, results, and interaction gathering module 195 is stopped for this search and archival user profile/history data may be stored. If not, the methods of the blocks 307, 309 through 335 are continued until a session is completed.

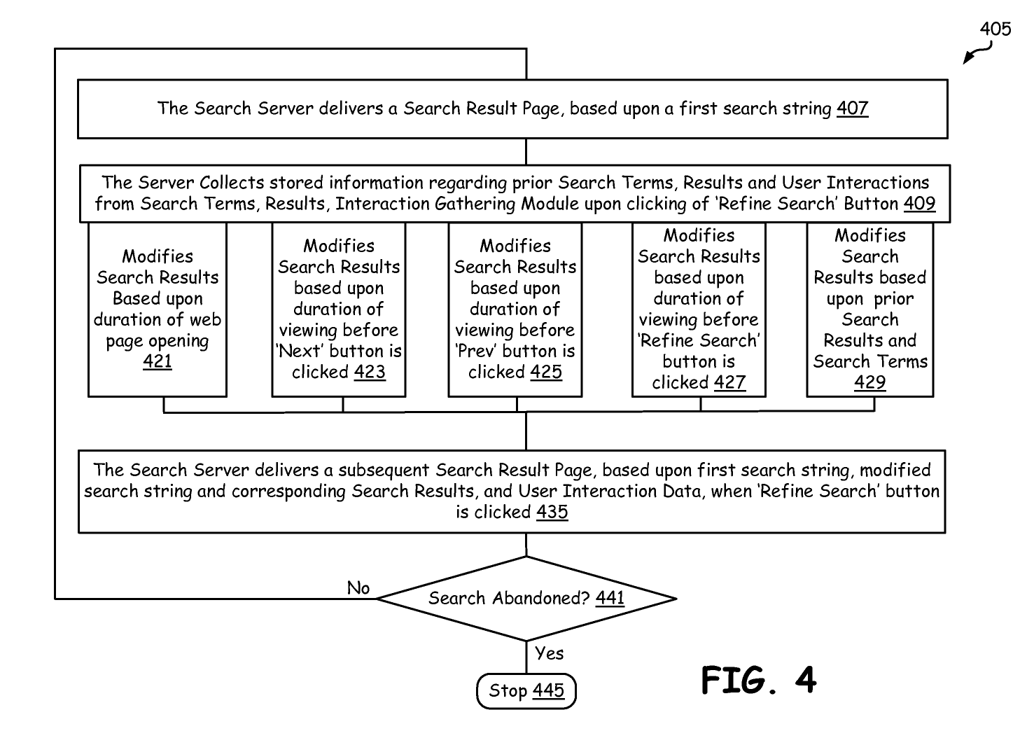

FIG. 4 is a flow diagram illustrating functionality of the search server of FIG. 1 upon receiving a search string from web browser of a client device, in accordance with the embodiments taught herein. The functionality begins with the search server delivering a search result page (first of first set of search result pages) via a block or step 407 in FIG. 4, based upon the processing of a first search string by the server and/or the client device. At a next block or step 409, the search server collects information regarding prior search terms, results and user interactions from search terms, results and interaction gathering module upon clicking of ‘refine search’ button. This information is used to generate modified (refined) search results in the subsequent (set of) search result pages. The event of collecting the above-mentioned information may lead to one or more of actions of blocks 421, 423, 425, 427 and 429 from the search server. Note that some of these operations 421-429 of FIG. 4 may be redundant to the operations 321-331 set forth in FIG. 3. Therefore, in some cases, the server and the client may be doing redundant work or one or the other devices (client or server) may take priority and relieve the other from having to do similar work and communicate that work back and forth. Meaning the user interaction processing taught herein may be performed at neither of the server or client, at one of the server or client, or be redundantly performed at both locations, including other devices that may also be collecting this information over the Internet, like DNS servers (not shown in the figures).

At the block or step 421, the search server modifies search results based upon duration a web page was opened, processed, or viewed. For example, a short duration of opening of some of the pages may indicate that the user is not interested in that kind of web pages. A long duration of opening may indicate a lot of interest in content of that type or quality. No opening of a web page may indicate complete disinterest in that type of content. At the block or step 423, the search server (server 169 or server circuitry 207 in FIGS. 1 and 2 respectively) modifies search results based upon a duration of viewing of the current search result page before the ‘next’ button is clicked. At the block or step 425, the search server modifies various search results or lists thereof based upon the duration of viewing of the current search result page before a ‘prev’ button is clicked. At the block or step 427, the search server modifies search results or lists thereof based upon a duration of viewing of the current search result page before a ‘refine search’ button is clicked. In this case, the search server utilizes all of the available information to narrow down search results to satisfy the user's interests. At the block or step 429, the search server modifies search results based upon prior search terms and search results in a manner to that similarity discussion in step 329 of FIG. 3 for client devices.

As an example, after delivery of a first search result page that is sorted by the server in priority on the basis of popularity, a clicking of ‘refine search’ button results in collecting and/or processing of user interaction data. Then, the user may modify the search string by adding one or two terms to it, seeking to focus the search results to the user's interests. This results in a modified second search result page. The search server modifies the second search result page by excluding web links, content, or search results that are similar to the web links in the first set of search result pages that were of little or no interest to the user, and generating new list of sorted web links based upon the modified search string and user interaction in order to present the user with more meaningful search results. The exclusion of web links and generation of second search result pages is determined by the user's lack of interest (or interest) in any of the web links in the first search result page, the user's modification of the search string, specific user feedback on search result desirability (see step 331 of FIG. 3), and any of the user interactions with the first search result page and search results therein.

In a next block 435, the search server delivers a subsequent (second) search result page, based upon first search string, modified search string and corresponding search results, and user interactions data, when ‘refine search’ button is clicked or another ‘refine search’ event is encountered by the system. The search server, at a next decision block 441, determines if the search is abandoned (that is, the search session is completed). If yes, the functionality of search server for the current session is stopped and search history and profile data may be stored for long term archival purposes and search profile processing and statistics. If not, the methods of the blocks 407 and 409 through 435 are continued till the search session is completed.

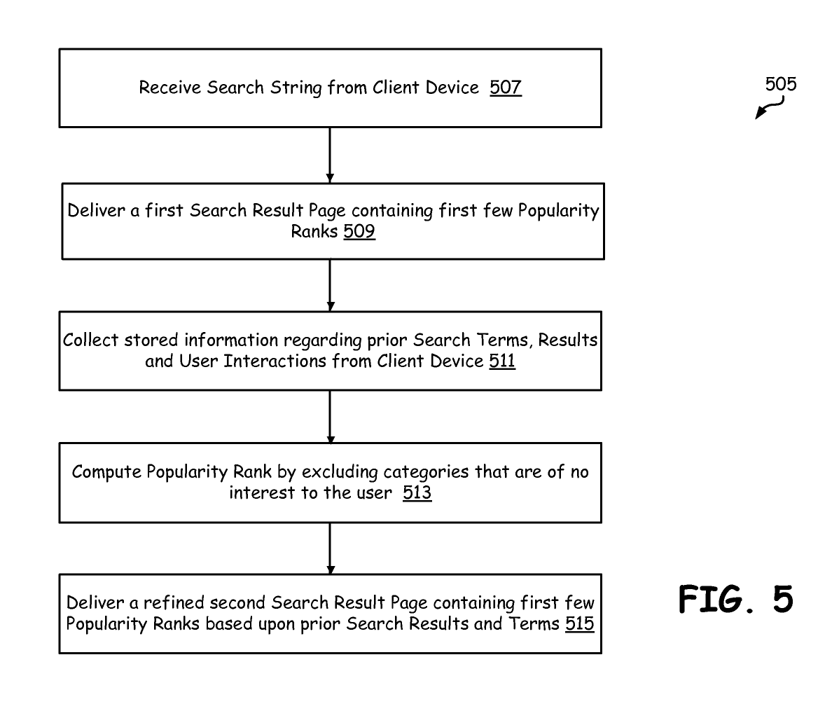

FIG. 5 is a flow diagram illustrating certain functionality of the search server of FIG. 1 when search operations are performed by the system. The functionality of the search server begins at a block or step 507, when the search server receives a search string from the client device. The search string may contain one or more key words or terms, and a user at the client device enters this search string in a web browser by using a search server's web page. At a next block or step 509, the search server delivers a first search result page to a user or a client device containing first few ranks of sorted search results sorted on the basis of popularity. These search results are delivered to the client device's web browser or other software or hardware on the client device. Note that the first search result page and other search results pages may also be sorted on criteria other than popularity, such as prior other user interactions with the words of the search string.

A search terms, results, interaction gathering module incorporated into the client device's web browser gathers the prior search terms (words in the search string), results (web links displayed in a search result page) and user interactions during the user viewing of the first search result page, until a button is clicked on the first search result page. At a next block or step 511, the search server collects stored information regarding prior search terms, results, and user interactions from the client device.

At a next block or step 513, the search server again computes popularity ranking by excluding web links and categories that are of lesser or no interest to the user. The user's interests regarding a search string are determined by monitoring, storing, organizing, and processing user interactions, prior search terms, and results within the system. At a last block or step 515, the search server delivers a refined second search result page containing search results having the newly computed first few popularity ranks based upon prior search results and terms. The process of delivering subsequent search result pages also accounts for prior search terms and results in a session.

FIG. 6 is a flow diagram illustrating functionality of the search server of FIG. 1, in greater detail than that shown in FIG. 5. The detailed functionality of the search server begins at a block or step 609, when the search server receives a search string from the user device or client device (mobile computer, laptop, net book, smart phone, cell phone, point of sale device, mobile internet device, personal computer (PC), server, etc) or another user device. The search server responds to the receiving of search string by delivering a search result page containing a set of search results or web pages that have the highest or most pertinent first few popularity ranks, via a next block or step 611.

At a next decision block or step 621, the search server determines if the ‘prev’ button is clicked in the delivered search result page. If yes, the search server delivers an exact previous search result page preferably using the same or previous popularity ranking, at a next block or step 635, and waits for any more clicking of buttons while processing user interaction, functions, and input. If no ‘prev’ button is pressed at the decision block or step 621, the search server determines if ‘next’ button is clicked at a next decision block or step 623. If yes in step 623, the search server delivers a search result page containing a next few popularity ranks using the same prior popularity ranks used for immediately preceding page(s), via a next block or step 637, and then the system waits for any clicking of any other buttons while the user continues search operations on that newly delivered content. The next few popularity ranks delivered with the clicking of the ‘next’ button may not contain any of refinement based upon the prior search terms, results and/or user interactions, but in another embodiment, the ‘next’ button can be selected or programmed to incorporate some degree of user interaction analysis as taught herein without requiring a pressing of the ‘refine search’ button. This, of course, is an alternate embodiment. So, in one embodiment, the ‘next’ button provides user an option to continue searching without refining the search results and in another embodiment, the ‘next’ button may provide those user-interaction-modified results.

If no ‘next’ button is pressed at the decision block or step 623, the search server determines if ‘refine search’ button is clicked at a next decision block or step 625. If yes, the search server retrieves stored information regarding prior search terms, results, and user interactions, at a next block or step 627. Note, this user interaction information is being intermittently or constantly monitored by the system (client, server, and/or other software/hardware) while the user is conducting a search. While this information is collected frequently, it may be only utilized to alter/refine user search results shown to the user only in specific cases, like when the ‘refine search’ button is pressed. Alternatively, the search server may also store search terms and results while delivering search result pages and retrieve only user interaction data from the client device. At a next block or step 629, the search server delivers a search result page, based upon prior search strings (prior search terms), modified search string (if any, within a given session) and corresponding search results, and user interactions; and waits for any clicking of buttons. This method of accounting for prior search terms, results, and user interactions continues for the entire session.

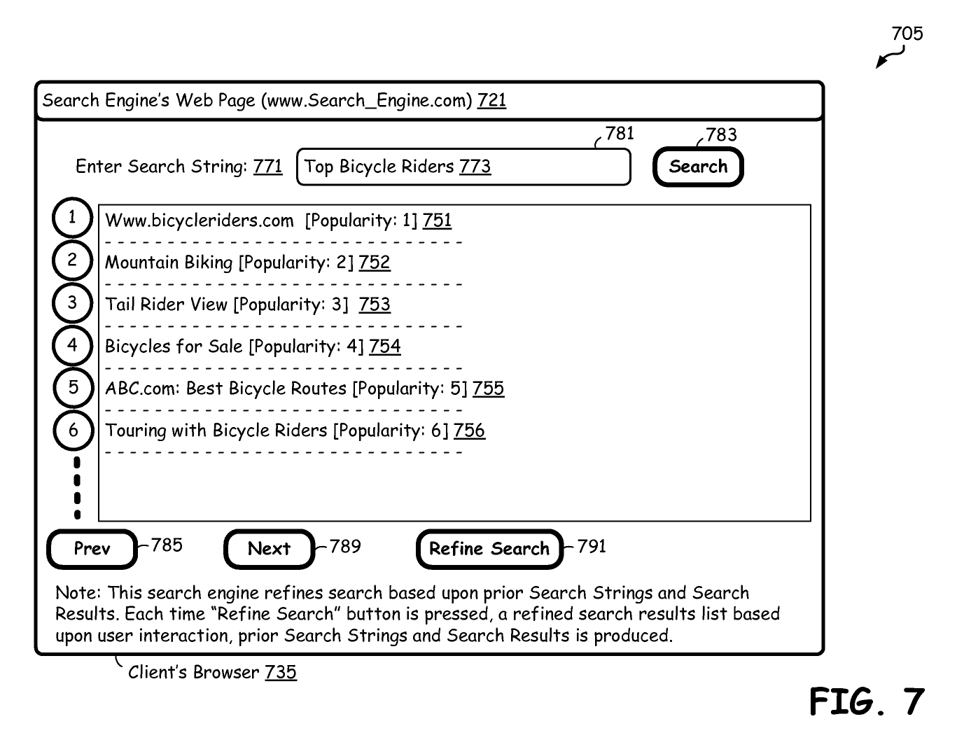

FIG. 7 is an exemplary block diagram illustrating snap shot of a display screen shown to the user. The screen shot shows a first set of search result pages based on a search string delivered by a web browser wherein the first set of search result pages contains list of web links sorted on the basis of popularity ranks. Specifically, the exemplary snap shot illustrated in FIG. 7 is based upon a search string “top bicycle riders” illustrated in the search string entry field 773 of FIG. 7 and the set of search result pages is delivered to the client's browser 735 which likely resides in a window within the OS and screen of the client device. All of the search result web pages delivered may contain a page title such as ‘Search Engine's web page (www.Search_Engine.com)’ 721, and ‘search’ 783, ‘prev’ 785, ‘next’ 789 and ‘refine search’ 791 buttons or other buttons labeled in different text and arranged in different ways yet providing a similar functionality. In addition a text string, such as ‘Enter Search String:’ prompt 771 and text box 781 is provided to facilitate user's search input.

A helpful note text that informs the user about the functioning of the search engine of the present invention may be provided, such as the note at the bottom of the screen of FIG. 7:
‘Note: This search engine refines search based upon prior search strings search results. Each time ‘Refine Search’ button is pressed, a refined search result list based upon user interaction, prior search strings, and search results is produced.’ may be provided with each of the search result web pages.’

In addition, the first set of search result pages also contains a window containing search result lists, usually of N web links where N is an integer and the search results may be numbered as 1, 2, 3 . . . N, and a good number for N is often 10, give or take, while any number N may be used. Out of these N web link results, the exemplary snap shot 705 illustrates first six web link lists, 751 through 756, which are ranked first by the system on the basic of Internet or network popularity. In this snap shot of the first of first set of search result pages, the web links 751 through 756 may contain assorted web links belonging to various categories, many of which may not interest the user.

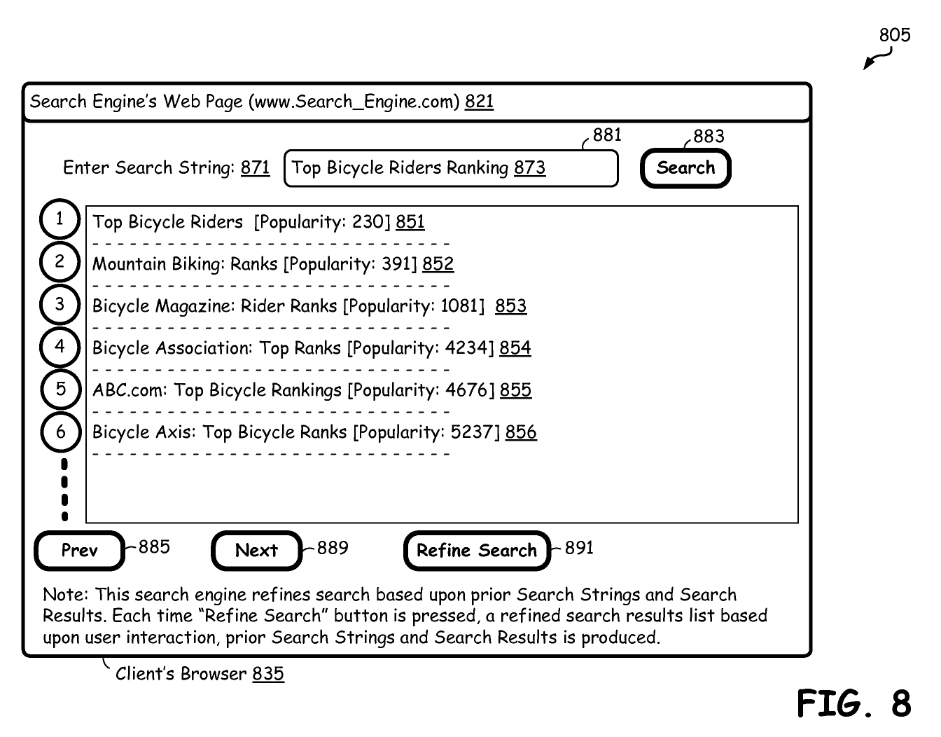

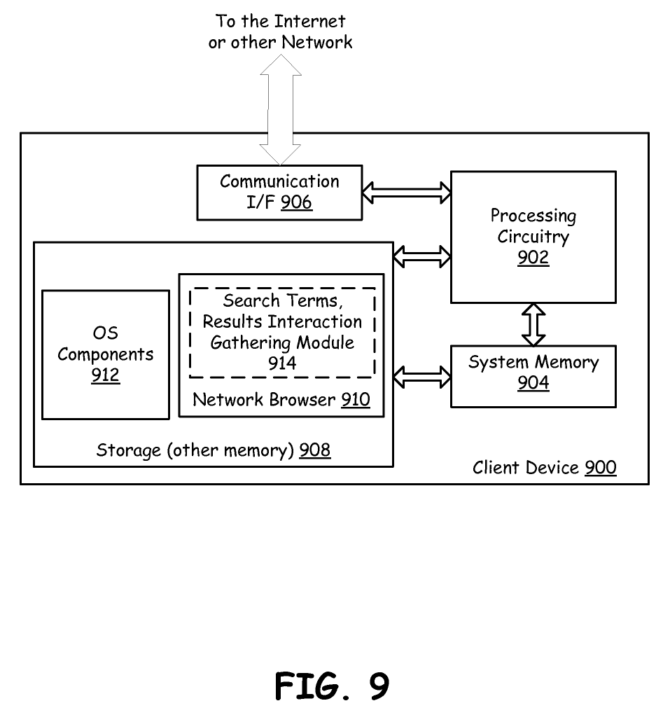

FIG. 8 is an exemplary block diagram illustrating snap shot of a second set of search result pages based on a search string delivered by a web browser wherein the second set of search result pages contains refined list of web links sorted on the basis of prior terms, results and user interactions and then preferably on secondary or additional consideration like popularity, presence or lack of presence in the prior search iterations for this search session, and rank in the prior search operation processing. The second set of search result pages result from modifying the search string after delivery of several search result pages based upon an original search string (first set of search result pages). For example, as illustrated in the snap shot of FIG. 7, the original search string may be ‘top bicycle riders’. After scrolling through several search result pages containing web links sorted on the basis of popularity ranks, the user may not find what is wanted and may modify the original search string by adding a term, resulting in a search string ‘top bicycle riders ranking’, as illustrated (italics indicating the added term). The user may add the terms ‘ranking’ hoping that the search server delivers web links that show top bicycle riders ranking in the world. In other cases, the user may simply interact with search results using the mouse, keyboard, voice commands, graphical user interfaces (GUIs), touch screens, laser pointers, buttons, etc., and the system can track these interaction and from those actions derive what type of content the user is more interested in among the popularity ranked initial first long list of search results (one search can result in hundreds, thousands, millions or more, of ‘hits’ or pertinent search results or web pages.

The second set of search result pages illustrated in FIG. 8 contains a window containing search result list, typically of 10 or so search results or web links as previously discussed, numbered as 1, 2, 3 . . . 10. Out of these 10 web link results, the exemplary snap shot 805 illustrates first six web link lists, 851 through 856, based upon popularity. In this snap shot of the second set of search result pages, the web links 851 through 856 may contain assorted web links belonging to various categories, and accounts for the prior search terms ‘top bicycle riders’ and the corresponding results, such as the web links illustrated in FIG. 7. Specifically, the illustration shows popularity ranks 230, 391, 1081, 4234, 4676, and 5237 (ranking numbers being taken from the rankings of the first set of search result pages). These web links 851 through 856 are generated when user clicks on ‘refine search’ button in a previous page and are narrowed down search results that are specific to user interests, that is, ranking of top bicycle riders in the world. Note, in a process that is not designed to monitor user interaction, input, and feedback into the search, system, the process simply would have returned 10 more searches with a rank ordered popularity of 11-20 to the user. Note, given the results shown in FIG. 8 that the user was not at all interested in any of the search results 11-20, and would have to progress though 23 pages to the popularity rank 230 to get his next pertinent piece of information. Given the ‘refine search’ button, the user monitoring and processing, and the steps taught herein, the user is progressed to search popularity rank 230, 391, 1081, 4234, 4676 and 5237 in very quick and efficient manner whereby a user can find more pertinent search results in a faster manner.

Basically, the algorithm taught herein can accelerate or collapse the entire field of relevant search terms down to more relevant and focused sub-sets of search terms in a short time by monitoring user interaction, user input, user profiles, user historical interests, etc, as they pertain to this search session, prior user search sessions, or prior Internet search sessions in this similar content space. As an example of the advantage of monitoring prior Internet search sessions in this similar content space, suppose a large earthquake had just hit India. People on the Internet are searching “earthquake damage.” This search string may lead to generic popular earthquake science web sites on the Internet that are ranked high over a long time using general popularity indicators. However, if the server notices that in the last 6 hours, 90% of the users entering a search of this or similar scope wanted to see current news on the recent earthquake in India, the server can provide content to the user accordingly and with greater likelihood that the server is providing the user relevant content to the search requested, under current search conditions, realities, and environments. Therefore, in essence, a search protocol that is more cognoscente of user input and surrounding search content and history is much more likely to provide meaningful content to a user in faster and more user-friendly manner.

All of the search result web pages delivered may contain a page title such as ‘Search Engine's web page (www.Search_Engine.com)’ 821, and ‘search’ 883, ‘prev’ 885, ‘next’ 889 and ‘refine search’ 891 buttons. In addition a text such as ‘Enter Search String:’ 871 and text box 881 is provided to facilitate user's search. A helpful note or end text may be provided to inform the user about the functioning of the search engine of the present invention as also shown and described in FIG. 7.

FIG. 9 illustrated a client device 900 which illustrated in for detail the client devices 157 and 261 of FIGS. 1 and 2 respectively. The client device 900 is most often an end user device such as a phone, mobile internet device, laptop, desktop, or other personal computing device, but is some cases may also be a more powerful server based machine or workstation. A communication interface 906 couples the client device 900 to the Internet or another wire line, optimal, wireless, or other network via one or more wired, optical, and/or wireless links. For example, when the client device 900 is a desktop computer or a laptop computer, the communication interface 906 may be a wired Ethernet Interface or a Wireless Local Area Network (WLAN) interface. When the client device is a portable device such as a laptop computer, data terminal, or cellular telephone, for example, the communication interface 906 may be a cellular interface, a Wireless Wide Area Network (WWAN) interface, e.g., WiMAX interface, a WLAN interface, or another type of wireless interface. Any of these client devices 900 may support one or more of either/both wired and wireless interfaces.

A network browser 910 runs as an application program over the client Operating System (OS) 912. All or a substantial portion of the system software and application software components reside in the system Storage (other memory) 908, which is usually computer readable medium or memory devices of some sort, such a flash disk, hard drive, nonvolatile memory, or the like, but may be random access memory similar to system memory 904. All the applications are run by a central processing unit (CPU) or processing circuitry 902, after being loaded into System Memory 904. The CPU may be a general-purpose processor, an application specific integrated circuit (ASIC), an field programmable gate array (FPGA), a graphics processing unit (GPU), digital signal processor (DSP), an embedded controller, a microcontroller unit (MCU), or any other form of execution unit or combinations of the foregoing. System memory 904 is often static random access memory (SRAM), dynamic random access memory (DRAM), cache, a peripheral IC chip, or some other computer readable medium. The Module 914 is similar to the module illustrated and described in FIGS. 1-2 as modules 195 and 295 respectively. Module 914 may be a software component of network browser 111, may be a separate software application from the browser running on the OS 912, or may be dedicated hardware and/or software running in connection with a client device 900. In some cases, especially in circumstances where greater security is required, the module 914 may contain hardware components or plug in security cards or disks as well.

The terms “circuit” and “circuitry” as used herein may refer to an independent circuit or to a portion of a multifunctional circuit that performs multiple underlying functions. For example, depending on the embodiment, processing circuitry may be implemented as a single chip processor/CPU or as a plurality of processing chips connected together and possibly accessing software or firmware on internal or external memory. Likewise, a first circuit and a second circuit may be combined in one embodiment into a single circuit or, in another embodiment, operate independently perhaps in separate chips and/or viewed as separate circuits. The term “chip,” as used herein, refers to an integrated circuit. Circuits and circuitry may comprise general or specific purpose hardware, or may comprise such hardware and associated software such as firmware, interpreted code, executable code, binary, or object code.

As one of ordinary skill in the art will appreciate, the terms “operably coupled” and “communicatively coupled,” as may be used herein, include direct coupling and indirect coupling of components, elements, circuits, features, steps, blocks, and/or modules where, for indirect coupling, the intervening component, element, circuit, or module may modify the information of a signal and may adjust its current level, voltage level, and/or power level. As one of ordinary skill in the art will also appreciate, inferred coupling (i.e., where one element is coupled to another element by inference) includes direct and indirect coupling between two elements in the same manner as “operably coupled” and “communicatively coupled.”

The embodiments taught herein also have been described above with the aid of method steps illustrating the performance of specified functions and relationships thereof. The boundaries and sequence of these functional building blocks and method steps have been arbitrarily defined herein for convenience of description. Alternate boundaries, orders, and sequences can be defined so long as the specified functions and relationships are appropriately performed. As a specific example of this in FIG. 6, FIG. 6 is described as checking in a looping fashion for first a ‘prev’ button, then a ‘next’ button, then a ‘refine search’ button. There is no reason why the order of these operations can't be changed and arrive at the same functionality. Therefore, any such alternate boundaries, orders, or sequences are thus within the scope and spirit of the claimed invention and the embodiments taught herein.

The present invention has been described above with the aid of functional building blocks illustrating the performance of certain significant functions. The boundaries and internal function of these functional building blocks have been arbitrarily defined for convenience of description. Alternate boundaries and additional or lesser functions could be defined as long as the certain material functions are appropriately performed. This basically means that some functions are optional and not required to render a useful and functional search protocol for a user. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention.

One of average skill in the art will also recognize that the functional building blocks, and other illustrative blocks, modules and components herein, can be implemented as illustrated or by discrete components, application specific integrated circuits, processors executing appropriate software and the like or any combination thereof, it is also important to note that if the client device 157 of FIG. 1 is a dumb terminal or thin client, then software/module 195 may reside on another block of piece of hardware in the system, such as server 169 or another client, hardware, software, or server device within FIG. 1 or potential not shown in FIG. 1 but a part of the Internet 107 or another appended network, device, link, intranet, etc., not shown in FIG. 1.

Search results are often taught herein as being web pages. It is important to note that other search results such as data, records, inventory, text files, news, PDFs, executable software, videos, music, media files, and other information may be searched per the embodiments described herein.

It is also important to note that FIG. 1 illustrated the server containing four modules 171-177, and that these modules may instead reside in the client device or another device within the network of FIG. 1. The information processed and stored server side in FIG. 1 may be moved client side and simply required a different form of collaboration and communication between the server and the client device over the Intranet.

Moreover, although described in detail for purposes of clarity and understanding by way of the aforementioned embodiments, the claimed invention is not limited to such specific and static embodiments. It will be obvious to one of average skill in the art that various changes and modifications may be practiced within the spirit and scope of the invention, as limited only by the scope of the appended claims.

1. A client device operable to be coupled to an Internet infrastructure, the client device comprising:
a communication interface;
memory containing at least a portion of a user interaction gathering module; and
processing circuitry coupled to the communication interface and to the memory, the processing circuitry, memory, and communication interface operable to:
receive as input a search string from a user;
output search string information via the communication interface for eventual receipt and processing by an external search server,
receive search result pages of a first set of search results based upon the search string;
display the search results
use the user interaction gathering module to gather prior search terms, results and user interactions with the first set of search result pages;
send, via the user interaction gathering module information external to the client device via the communication interface for processing by an external search server;
accepting modified search string information and using such modified search string information to change search operations performed with the aid of the external search server; and
receiving a second set of search result pages, comprising refined search results based upon the prior search terms, results, and user interactions that were gathered by user interaction gathering module.

2. The client device of claim 1, wherein the refined search results exclude search results that are similar to search results originally identified as part of the first set of search result pages and found to be of little interest to the user via information gathered by the user interaction gathering module.

3. The client device of claim 1, wherein the refined results include web links that are of high user interest, based upon gathered user interaction data via the user interaction gathering module.

4. The client device of claim 1, wherein the refined results include web links that are based upon words received by the client device within the modified search string information.

5. The client device of claim 1, wherein the second set of search result pages are also identified by processing one or more of: (i) user historical search data; (ii) a user profile giving information about the user; and (iii) current environment data that can help correlate the current user's search to searches recently performed by other users seeking similar information.

6. The client device of claim 1, wherein each of the delivered search result pages in the first set of search result pages and second set of search result pages comprises the provision of a ‘next’ button that when pressed refines subsequent search results at least in part based on information from the user interaction gathering module.

7. The client device of claim 1, wherein each of the delivered search result pages in the first set of search result pages and second set of search result pages comprises the provision of a ‘next’ button that when pressed provides a next set of search result pages without resorting to the information stored by the user interaction gathering module and wherein each of the delivered search result pages in the first set of search result pages and second set of search result pages comprises the provision of a ‘refine search’ button that when pressed refines subsequent search results at least in part based on information from the user interaction gathering module.

8. The client device of claim 7, wherein the next search result page comprises search results ordered on the basis of popularity ranks.

9. The client device of claim 1, wherein each of the delivered search result pages in the first set of search result pages and second set of search result pages comprises a ‘prev’ button that allow a user to move background to process previously displayed search results.

10. The client device of claim 9, wherein the search server responds to the clicking of the ‘prev’ button by delivering an exact previous search result page and begins to collect new information of user interaction on this previous search result page via the user interaction gathering module.

11. The client device of claim 1, wherein the search server further comprises a search result processing and refinement module that deviates the client device from the normal popularity based provision of search results and provides search results to the user that are based on user interaction as recorded by the user interaction gathering module and popularity as an additional consideration.

12. The client device of claim 11, wherein the search result processing and refinement module generates refines search results provided to the user based upon the prior search terms, prior-provided search results, and user interactions with prior-provided search results.

13. A search device that supports delivery of search result pages of web links to a user device based upon a search string, the search device comprising:
a prior search terms storing module, that stores prior search terms provided by a user over a communication interface until at least a current search session is completed;
a prior search results storing module, that stores prior search results until a search session is completed;
a prior interaction storing module, that stores prior user interactions with various search results at least until a search session is completed;
a search result processing and refinement module that identifies what subsequent search results to provide to the user based upon one or more pieces of information stored by the prior search terms storing module, the prior search results storing module, or the prior interaction storing module.

14. The search device of claim 13, wherein the search session uses search strings that are modified to create modified search string input over time during the current search session where the modified search string input is then used to modify search results provided to the user.

15. The search device of claim 13, wherein the subsequent search results comprise search results that exclude web links similar in content to certain prior search result pages that were not interacted with by the user.

16. The search device of claim 13, wherein the prior interaction storing module stores user interaction across many search sessions to derive a user profile for the user that can be used for later search sessions to help determine which search results would be of more interest to the user.

17. The search device of claim 13, wherein the prior interaction storing module accesses search information from similar searches recently performed by other users to help determine which search results would be of more interest to the user.

18. A method performed by a search device that supports a web browser, the method comprising:
receiving a search string from user input that was provided into the web browser;
receiving, via a communication interface, a first set of search result pages containing a list of a first few popularity ranks based upon a processing of the search string;
initiating collection of stored information regarding prior search terms, results and user interactions as the user processes the first set of search result pages using the web browser;
initiating the computing of a second set of search result pages containing search results that have a set of new popularity ranks by excluding web links that are similar in scope to search results in the first set of search result pages that were of no real interest to user; and
assembling the second set of search result pages containing the list of new ranks; and
delivering the second set of search result pages to the user via the web browser and a communication interface.

19. The method of claim 18, wherein the excluding web links that are of no interest to user involves excluding web links that are similar in context to that found in the prior search result pages where the user did not interact with these prior search result pages.

20. The method of claim 18, wherein the second set of search result pages are generated after some user modification to the prior search terms and wherein the second set of search result pages are influenced by the user modification to the prior search terms.
